(19) United States
(12) Patent Application Publication
(10) Pub. No.: US 2012/0103903 A1
(43) Pub. Date: May 3, 2012

(54) METHODS, APPARATUS, AND SYSTEMS FOR SEPARATING FLUIDS

(75) Inventors: Michael Hill, Wyckoff, NJ (US); Edward F. Leonard, Bronxville, NY (US)

(73) Assignee: The Trustees of Columbia University in the city of New York, New York, NY (US)

(21) Appl. No.: 13/265,201

(22) PCT Filed: Apr. 19, 2010
(86) PCT No.: PCT/US10/31600

§ 371 Date: Jan. 3, 2012

Related U.S. Application Data
(60) Provisional application No. 61/171,061, filed on Apr. 20, 2009.
(60) Provisional application No. 61/176,740, filed on May 8, 2009.

(51) Int. Cl. B01D 29/00

(52) U.S. Cl. 210/649; 210/348

(57) ABSTRACT

A device for separating fluids includes a microfluidic channel with one or more wall filters or membranes through which portions of the flow in the microfluidic channel can be removed. The wall filters can have precisely defined pores therein which restrict the removal of certain particles while allowing other particles and/or fluids to freely flow therethrough. Because of the high and uniform pore density and low flow resistance of these filters, the pressure drop along the microfluidic channel may result in a negative trans-filter pressure, thereby causing reverse flow of extracted fluid back through the filter and into the microfluidic channel. Precise design of the microfluidic channel and control of flow characteristics can minimize and/or eliminate this reverse flow while allowing for sufficient sweeping of the filter surface to inhibit clogging with particles.

### CROSS-REFERENCE TO RELATED APPLICATIONS

The present application claims the benefit of U.S. Provisional Application No. 61/171,061, filed Apr. 20, 2009, and U.S. Provisional Application No. 61/176,740, filed May 8, 2009, both of which are hereby incorporated by reference herein in their entireties.

### STATEMENT REGARDING FEDERALLY SPONSORED RESEARCH

This invention was made with U.S. government support under 1R21 HL088162-02A1, awarded by the National Institute of Health. The U.S. government has certain rights in the invention.

### FIELD

The present disclosure relates generally to the filtration and/or separation of fluids, and, more particularly, to the cross-filtration of fluids from a microfluidic channel using low flow resistance filters or membranes.

### DESCRIPTION OF EMBODIMENTS

Methods, apparatus, and systems for separating fluids employ cross-filtration in a microfluidic channel using filters or membranes. A microfluidic channel can include one or more wall filters through which components of the flow in the microfluidic channel can be removed. The flow through the wall filters can be in a direction crossing or substantially perpendicular to the predominant flow down the microfluidic channel. This mechanism of filtration is referred to as cross-filtration or cross-flow filtration.

The wall filters, according to respective embodiments, may be membranes, depth loading filters, reticular structures, single layer porous structures with machined (e.g., ion- or chemically-etched, mechanically machined, or created any other suitable mechanism) pores (e.g., van Rijn filters) which restrict or impede the traversal of certain particles or other species while allowing other particles and/or fluids to flow more freely therethrough. For example, wall filters identified as micro-sieves or nano-sieves are described in U.S. Pat. No. 5,753,014 (also referred to as van Rijn filters). Because of the high and uniform density of pores in these filters and their low flow resistance, the pressure drop along the microfluidic channel (i.e., any kind of fluid-conveying structure or channel, in combination with fluid properties and flow rates, in which high streamwise pressure drop may occur) may result in a negative trans-filter pressure, thereby causing reverse flow of extracted fluid back through the filter and into the microfluidic channel. When a highly permeable membrane or filter is used, the pressure drop along the microfluidic channel may similarly result in a negative transmembrane pressure, also causing reverse flow of extracted fluid through the membrane and into the microfluidic channel. The structure of the microfluidic channel and control of flow characteristics can minimize and/or eliminate such reverse flow.

Note that throughout this disclosure the structure of a portion of a cross-flow channel through which a flow exits the channel may be, or may be referred to as, a filter or a membrane, or more generically as a “permeable structure;” however, it is intended that any kind of permeable structure falls within the scope of the disclosed subject matter and may be interchanged to produce alternative embodiments. These may include membranes, depth loading filters, reticular structures, electrodes, or single or multi-layer porous structures with machined pores. The permeable structure may have active or inert surfaces.

According to embodiments, a microfluidic separation device can include a separation channel with an input end and an output end separated by a length and defining a direction of flow through the separation channel. A ratio of a separation channel width to a separation channel height can be more than 10. The separation channel height may be no more than 300 μm. Both the separation channel width and the separation channel height are in a direction perpendicular to the direction of flow.

The separation device can include two inlet extraction fluid ports and one inlet sample fluid port. These ports may be microfluidic ports that connect the separation channel to other microfluidic structures such as fluid component analysis (“lab on a chip”) devices. For example, the separation device may be integrated with a microfluidic chip to provide post- or pre-processing for another microfluidic device or processing stage thereof. The inlet sample fluid port can be located between the two inlet extraction fluid ports and proximate to the input end. The separation device can include two outlet extraction fluid ports and one outlet sample fluid port. The outlet sample fluid port can be located between the two outlet extraction fluid ports and proximate to the output end. Each of the outlet extraction fluid ports can have a filter with a length in the direction of flow through the separation channel. As used herein, port can refer to an opening, channel, tubing, connection, connector, or other fluid conveyance mechanism. Thus, as mentioned, an inlet port or outlet port can be another microfluidic channel that couples the separation device to another microfluidic device on the same or different chip or substrate.

The separation device can also include at least one fluid drive configured to convey sample and extraction fluids into the separation channel and out of the two outlet extraction fluid ports and the outlet sample fluid port at respective flow rates. The filters, the at least one fluid drive, and the separation channel may be configured so as to maintain a positive trans-filter pressure along the length of each filter.

A method of separating fluid components from a sample fluid can include providing a rectilinear microfluidic channel with a length and a smooth filter in a wall thereof. The filter can have a regular array of holes therein, which are sized so as to block the passage of particles of a predetermined size. Alternatively, the filter can be a semi-permeable membrane with the ability to hold back solutes of a certain molecular weight.

The method can optionally include co-flowing sample fluid and an extraction fluid in the microfluidic channel such that the sample fluid is adjacent to the extraction fluid. The co-flowing can establish a laminar, non-mixing flow in which diffusion of components between the sample and extraction fluids can occur. The sample fluid initially flowing into the microfluidic channel can contain particles.

The method can also include drawing at least a fraction of the extraction fluid through the filter at a filtering rate. Where no extraction fluid is present, the method can include drawing at least a portion of the sample fluid through the filter at a filtering rate. A positive pressure difference from the microfluidic channel across the filter can be maintained at all points of the filter by suitably controlling the rate of extraction along the filter. The flow of fluid through the filter can be at a maximum at an upstream end of the filter and can progressively fall toward zero at a point that coincides with a downstream end of the filter.

A method of filtering fluid in a laminar cross-flow can include flowing at least one fluid, at a channel flow rate, through a microfluidic channel having a wall filter in a wall of the channel. The channel flow rate is a volume flow rate at an upstream end of the channel. The method can also include drawing a portion of the at least one fluid through the wall filter or membrane at a filtering rate, which is a volume flow rate of the drawing. The channel flow rate and the filtering rate are such that the flow of fluid through the wall filter is at a maximum positive rate at an upstream end of the wall filter and progressively falls toward zero at a point that coincides with a downstream end of the wall filter.

A method of separating fluid components from a sample fluid can include flowing fluid through a microfluidic channel at a first flow rate. The microfluidic channel can have a filter in a wall thereof. The filter can have a regular array of pores therein and a length in the direction of fluid flowing through the microfluidic channel. The method can further include extracting fluid from the microfluidic channel through the filter at a second flow rate. The flowing and the extracting can be such that extracted fluid does not re-enter the microfluidic channel through said filter at any point along the length thereof.

A microfluidic separation device can include a separation channel having an input end, an output end, and a height less than 300 μm. The separation device can include a sample inlet port, a sample outlet port, and an extraction outlet port. The sample inlet port can be located proximate to the input end, and one or more of the outlet ports can be located proximate to the output end. The inlet and/or outlet ports may be connected to other microfluidic devices on a common or separate microfluidic chip via one or more channels so as to form, for example, an integrated lab-on-a-chip device or micro-total analysis system. The separation device can further include at least one fluid drive configured to convey fluid into the separation channel through the sample inlet port and out of the separation channel through the respective outlet ports at respective volumetric flow rates.

The extraction outlet port can have a wall filter or membrane that forms a portion of a wall of the separation channel. Alternatively, the sample outlet port can have a wall filter or membrane that forms a portion of the wall of the separation channel. The wall filter or membrane can have a length, L, in a direction of flow from the input end to the output end of the separation channel that satisifies:

$$L = \frac{1}{β} {cosh}^{- 1} ( \frac{{Q}_{1}}{{Q}_{2}} ) ,$$

where Q₁ is the volumetric flow rate down the separation channel at the leading edge of the filter or membrane, Q₂ is the volumetric flow rate down the separation channel at the trailing edge of the filter or membrane, and

$$β = \sqrt{\frac{3 μ A}{{B}^{3}}} ,$$

where μ is the viscosity of the sample fluid, A is the permeability of the filter or membrane, and 2B is the height of the separation channel. The permeability can be defined as the ratio of the flux of a homogeneous fluid through the filter or membrane to the trans-filter or transmembrane pressure required to achieve that flux.

A microfluidic separation device can include a separation channel having an input end and an output end separated by a length and defining a direction of flow through the separation channel. The separation device can also include at least a fluid inlet port located proximate to the input end. The separation device further includes at least one fluid outlet port located proximate to the output end. At least one fluid outlet port can have a wall filter that forms a portion of a wall of the separation channel. The wall filter can have a length along said direction of flow that is between 0.1 cm and 6 cm. The separation device can have at least one fluid drive configured to convey sample and extraction fluids into the separation channel through the respective inlet ports and out of the separation channel through the respective outlet ports at respective volumetric flow rates.

An integrated microfluidic device can include a first processing device and a separation device on a substrate. The first processing device can be configured to generate fluid with particles therein. The separation device can be directly coupled to the first processing device. The separation device can be configured to separate the particles from at least a portion of the generated fluid by cross-filtration.

### BRIEF DESCRIPTION OF DRAWINGS

Embodiments will hereinafter be described in detail below with reference to the accompanying drawings, wherein like reference numerals represent like elements. The accompanying drawings have not necessarily been drawn to scale. Any values dimensions illustrated in the accompanying graphs and figures are for illustration purposes only and may not represent actual or preferred values or dimensions. Where applicable, some features may not be illustrated to assist in the description of underlying features.

FIG. 1 shows a microfluidic channel with filters in extraction fluid inlets and outlets, according to one or more embodiments of the disclosed subject matter.

FIG. 2A is a close-up isometric view of one of the filters in an extraction fluid outlet of the microfluidic channel of FIG. 1.

FIG. 2B is a side view of the extraction fluid outlet area of the microfluidic channel of FIG. 1

FIG. 3 shows a microfluidic channel with filters in extraction fluid outlets, according to one or more embodiments of the disclosed subject matter.

FIG. 4 shows a microfluidic channel with filters in multiple extraction fluid outlets and varying restrictions in a common extraction fluid outlet channel, according to one or more embodiments of the disclosed subject matter.

FIG. 5 shows a configuration for controlling fluid flow in a microfluidic channel, according to one or more embodiments of the disclosed subject matter.

FIG. 6 shows a configuration for controlling fluid flow in a microfluidic channel by regulating flow in separate exit channels, according to one or more embodiments of the disclosed subject matter.

FIG. 7 is a graph representing the variation of trans-filter or transmembrane pressure at a trailing end of the filter as a function of filter length, according to one or more embodiments of the disclosed subject matter.

FIG. 8 is a graph showing the minimum required filter area for different flow conditions, according to one or more embodiments of the disclosed subject matter.

FIG. 9 shows a microfluidic channel with filters in fluid outlets, according to one or more embodiments of the disclosed subject matter.

FIG. 10 shows a microfluidic channel with a filter in a single fluid outlet, according to one or more embodiments of the disclosed subject matter.

FIG. 11 is a schematic diagram of an integrated microfluidic device with one or more processing devices and a separation device, according to one or more embodiments of the disclosed subject matter.

FIG. 12 shows a multiple sub-channel device with inlet and outlet manifold structures, according to one or more embodiments of the disclosed subject matter.

### DESCRIPTION OF DRAWINGS AND FURTHER EMBODIMENTS

A set of embodiments relating to sample fluid separation and to blood processing is described below to illustrate a useful application of the disclosed subject matter. However, as will be clear from the description, the disclosed subject matter is not restricted to the blood processing applications described. This point is highlighted further below, for example, with reference to FIGS. 9-11.

By contacting sample fluid in a microchannel with a co-flowing fluid, referred to herein as an extraction or sheath fluid, molecular components in the sample fluid can be transferred to the extraction fluid and subsequently removed from the microchannel with the extraction fluid. As discussed in U.S. Patent Application Publication No. 2006/0076295 to Leonard et al., filed May 12, 2005, hereby incorporated by reference in its entirety, flow patterns and species exchanges occur when a sample fluid is conveyed as a thin layer adjacent to, or between, concurrently flowing layers of an extraction fluid, without an intervening membrane (i.e., membraneless). In the '295 publication, the extraction fluid is alternatively described as a sheath fluid, a sheathing fluid, extractor fluid, and a secondary fluid. The extraction fluid, moreover, is generally miscible with the sample fluid and diffusive and convective transport of all components is expected. Although embodiments are described in the '295 publication which relates to the separation of co-flowing fluids in a microchannel, the principles described therein can be applied to cross-flow filtration of a single phase fluid.

As taught in U.S. Patent Application Publication No. 2009/0139931 to Leonard et al., filed Jul. 17, 2007, hereby incorporated by reference in its entirety, a microfluidic flow channel capable of separating solids or particles in a fluid from other components may also employ filters, such as nanoporous membranes with substantially uniform, short pores and high void fractions. The filters thus serve to introduce and/or remove extraction fluids from the microfluidic channel, while maintaining certain desirable contents within the microfluidic channel. In the '931 publication, the extraction fluid is variously characterized as a secondary fluid, a miscible fluid, and an extraction fluid. The embodiments of microfluidic separation channels with wall filters as described in the '931 publication may be employed in, for example, the walls of any of the microfluidic separation channels described in the present disclosure.

The wall filters as discussed herein may be micro-porous or nano-porous filters membranes, which have a plurality of regular or straight channel openings, such as provided by lithographically machined single-layer nanopore filters (e.g., van Rijn), that allow some components to pass therethrough. For example, the wall filters may retain certain components in the main microfluidic channel (referred to as a separation or extraction channel) by preventing the passage of the components therethrough into an outlet channel. In another example, the wall filters may retain certain components in an inlet channel by preventing the passage of the components therethrough into the main microfluidic channel.

The micro-porous or nano-porous filters or membranes may be micro-filtration devices, such as van Rijn filters. Such filtration devices are alternatively referred to herein as micro-sieves or nano-sieves, depending on the pore size. Membranes and filters may be used interchangeably in the disclosed embodiments, depending on the application and fluids involved. In general, the membranes and filters can have similar characteristics with respect to the fluid flow to avoid reverse flow therethrough as defined herein.

The filters can have a smooth and regular surface, in particular, the surface facing the microfluidic separation channel, so as to permit the flow in the channel to scour the surface clean and to help prevent the trapping of particles or macromolecules on the filter surface. In addition, the channels or pores defined in the filter can form a regular array. The channels or pores can be non-serpentine and/or non-branching. Also, the filters can provide a smooth and direct flow path for fluid and/or particles passing therethrough.

The filter, including any support structure, can be such that particles flow directly through the pore channels without adhering or being trapped in small surface features of the filter. The technology for creating and materials for such filters are numerous, and it is expected that they will continue to be developed and refined. Embodiments disclosed herein are not limited to any particular method for making or structure for the filters, though the properties described are useful in applications in which blood or blood fluid is processed.

By using a microfluidic channel, the separation of components in flowing sample fluid, such as blood, into layers may facilitate the further processing. The separation effect in the microfluidic channel can allow a cell-enriched blood layer to be sheathed by a pair of cell-depleted extraction fluid layers, thereby minimizing and/or reducing contact of blood components with the walls of the channel. The extraction fluid can substantially reduce and/or inhibit contact between the flowing blood and the walls of the microfluidic channel, including any filters disposed in the walls and/or outlets of the microfluidic channel. Such a configuration prevents, or at least inhibits, the undesirable activation of clotting or complement system factors in the blood, thereby reducing bio-incompatibilities that can be problematic in blood processing.

The microfluidic separation device can have channels with a height no more than 300 μm, for example, in the range from 60 μm to 200 μm, inclusive. As used herein, the terms “height” or “depth” refer to the dimension of the microfluidic channel perpendicular to the direction of flow and perpendicular to the interfacial area across which component transport between the sample fluid and the extraction fluid occurs. Appropriate selection of channel height may be based on filter flow considerations, as discussed in greater detail below.

The microfluidic separation device can have channels with a width that is at least ten times the height. As used herein, the term “width” refers to the dimension of the microfluidic channel perpendicular to the direction of flow and parallel to the interfacial area across which component transport between the sample fluid and the extraction fluid occurs.

The extraction fluid that flows through the microfluidic channel adjacent to and in contact with the sample fluid can be miscible with the sample fluid such that diffusive and convective transport of all components is possible.

Such diffusive and convective transport is accomplished without turbulent mixing of the sample fluid and the extraction fluid. In alternative embodiments, no extraction fluid is provided, so that only the sample fluid flows in the microfluidic channel.

When present the extraction fluid can be withdrawn from the microfluidic channel through thin barriers. When no extraction fluid is present, at least a portion of the same fluid can be withdrawn from the microfluidic channel through the thin barriers. These barriers can either have pores (i.e., wall filters) or be semi-permeable membranes having certain critical properties. The barriers can have a permeability from 1×10⁻⁶ cm²s/g to 2×10⁻⁵ cm²s/g, inclusive. The barriers can have a filter area between 2 cm² and 200 cm², inclusive. When the barriers have pores, the pore diameter can range from about 40 nm to 10 μm, inclusive. In addition, the pores can be distributed throughout the filter area at a density of between 1 million pores/cm² and 100 million pores/cm², inclusive.

The extraction fluids can be introduced into the microfluidic channel such that the extraction fluid flows adjacent to the top and bottom walls of the microfluidic channel. The combination of extremely thin layers of fluid and the absence of a membrane along the diffusive interface results in high transport speeds as compared to those obtained using membrane-based devices. This allows the total area that the sample fluid contacts to be relatively small as compared to membrane-based devices. In addition, surfaces in contact with the sample fluid adjacent to the microfluidic channel, such as the sample fluid inlet channel surface prior to the main extraction region, can also be relatively small. The total amount of contact between the sample fluid and any artificial surfaces can thereby be reduced further improving biocompatibility.

Withdrawing the extraction fluid from the microfluidic channel through a filter inhibits the build-up of certain components in the extraction fluid. For example, when using blood as the sample fluid, some blood cells may migrate into the extraction fluid during the time when the fluids are in contact in the microfluidic channel. It may be desirable in some scenarios to keep these blood cells (e.g., erythrocytes) in the sample fluid. The flow rates of sample and extraction fluids in the microfluidic channel can be controlled so as to allow for the layer formation. By this layering effect, blood cells and platelets concentrate in the middle of the sample fluid stream.

While layering reduces the amount of blood cells that end up in the extraction fluid, some cell migration may still occur. Thus, some blood cells may be subject to removal with the exiting extraction fluid flow. In order to keep the blood cells with the exiting sample fluid instead of the exiting extraction fluid, the extraction fluid outlets can be provided with wall filters. Appropriately-sized pores in the filters inhibit or at least reduce departure of this small number of blood cells from the extraction channel with the extraction fluid. Moreover, high shear rates may be used to provide a shear force at the surface of the filter sufficient to “sweep” this surface. Because the number of blood cells in the extraction fluid is kept relatively low, this sweeping action facilitates clearing of the surface of the filter of blood cells, thus aiding in the prevention, reduction, and/or minimizing of clogging. In addition, fluid flow characteristics, fluid interface velocity, and fluid contact time can be controlled to complement the selection of pore size in reducing or preventing loss of certain blood components and in reducing or preventing fouling.

Even with the wall filters, transport of molecular components of blood (e.g., non-cellular components such as blood proteins) to the extraction fluid may not be sufficiently discriminate, thereby allowing precious blood components to migrate from the sample fluid into the extraction fluid. The extraction fluid, carrying both those molecular components that are, and are not, desirable to remove from blood, can be removed through the extraction fluid outlet and conveyed to a secondary processor. The secondary processor regulates the operation of the microfluidic channel through the composition of the recycle stream that it returns (either directly or indirectly) to the extraction fluid inlets of the microfluidic channel. Moreover, a membrane-based secondary processor configured and used in this manner is able to achieve much higher separation velocities because cells, which are shear-susceptible, are not present in the extraction fluid provided to the secondary processor. Furthermore, concentration polarization (i.e., the accumulation of material rejected by the secondary processor on the upstream side of the separator) is limited to molecular components (e.g., proteins) and does not involve cells. Concentrations of molecular components in the extraction fluid can be regulated by selection of filter pore size, fluid flow characteristics, and fluid contact time. In addition, because cells are retained in the primary separator (i.e., the membraneless exchange device), they are exposed to artificial material only on along blood conduit surfaces, not on the liquid-liquid contact area, thereby reducing bio-incompatibilities. As such, the need for anticoagulation may be greatly reduced or eliminated.

A variety of different fluids may be provided as extraction fluids. These include plasma from an external source or recirculated from the membraneless channel. The latter plasma source may be derived by separating a component from the fluid in the microfluidic channel. For example, the extraction fluid may simply be a filtrate from the fluid in the microfluidic channel that has been recirculated back to the microfluidic channel. The extraction fluid can be, for example, substantially cell-free plasma derived from blood flowing in the microfluidic channel and recirculated back into contact with the blood flowing in the microfluidic channel.

Any mixture of external fluids and components of the sample fluid in the primary channel may be used as the extraction fluid. Examples of external fluids that may be used as, or form a component of, the extraction fluid where blood is the sample fluid include, but is not limited to, blood normal aqueous fluids, polymer fluids, and medicaments such as dialysate.

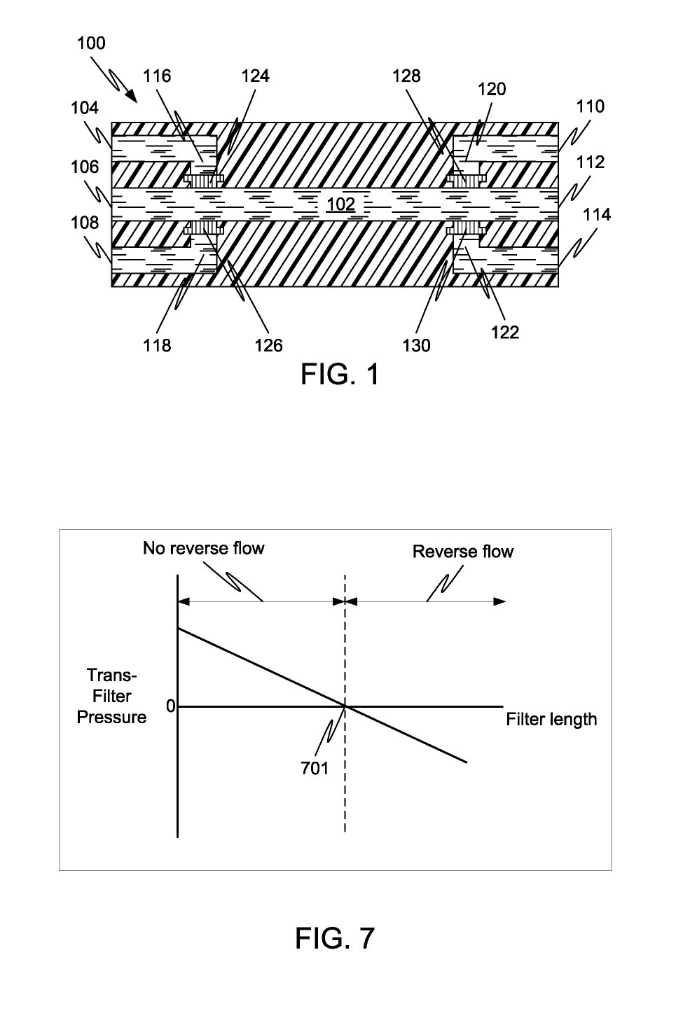

Referring now to FIG. 1, a microfluidic channel configured as a membraneless separation device 100 is shown with filters in extraction fluid inlets and outlets. A sample fluid is conveyed in a layer via inlet 106 into microfluidic channel 102. The sample fluid is sandwiched between two co-flowing extraction fluid layers, all of which flow together through the microfluidic channel 102. The extraction fluid is provided to the channel 102 through inlet ports 104 and 108 to respective inlet channels 116 and 118. Prior to entering the microfluidic channel 102, the extraction fluid passes through filters 124, 126 in the respective inlet channels 116 and 118. Note that filters 124 and 126 are optional, and either or both may be omitted according to one or more contemplated embodiments.

Relative to the oriented drawing page in FIG. 1, the microfluidic channel 102 has a width going into the page, a length in the horizontal direction, and a height or depth in the vertical direction. Generally, as used herein, the term “width” refers to a dimension of the microfluidic channel perpendicular to the direction of flow and parallel to the interface between the two liquids, “height” or “depth” refers to a dimension of the microfluidic channel perpendicular to the direction of flow and to the interface between the two fluids, and “length” refers to the dimension of the microfluidic channel parallel to the flow direction.

The flow in the microfluidic channel 102 creates two liquid-liquid boundaries between the sample fluid and the two extraction fluid layers, which can be arranged to substantially isolate the sample fluid from the artificial walls of the microfluidic channel 102. For example, the microfluidic channel 102 can be many times wider and longer than it is high. As a result, the sample fluid contacts the extraction fluid over a large area (length×width), but contacts the artificial walls of the channel 102 over a much smaller area (length×height of sample fluid layer) at the lateral edges. This provides a large interface between the sample and extraction fluids and effectively isolates the sample fluid from the walls of the microfluidic channel.

At an outlet end of the microfluidic channel 102, sample fluid can be removed via an outlet port 112. Moreover, extraction fluid outlet ports 110, 114 coupled to respective extraction fluid outlet channels 120, 122 can remove all or a portion of the extraction fluid adjacent the walls of the microfluidic channel 102. In addition, certain particles (e.g., cells, platelets, large particles) may be blocked from exiting with the extraction fluid through outlet channels 120, 122, by respective filters 128, 130.

Filters 124, 126, 128, and 130 may be placed in all or some of openings by which extraction fluid enters and leaves the extraction channel 102. The inlets/outlets and respective filters can extend across the width of the channel 102, so as to have access to extraction fluid throughout the entire microfluidic channel 102. Of course, other configurations for the outlets and filters are also possible according to one or more contemplated embodiments. For example, each filter can be formed by a plurality of individual filter elements arranged along the width and/or length of the filter to achieve the same or similar filtering effect. Alternatively, multiple inlets/outlets and respective filters can be arranged along the width of the channel 102. In yet another alternative, multiple inlets/outlets and respective filters can be arranged along the length of the microfluidic channel 102. Other arrangements for the inlets/outlets and the respective filters are also possible, according to one or more contemplated embodiments.

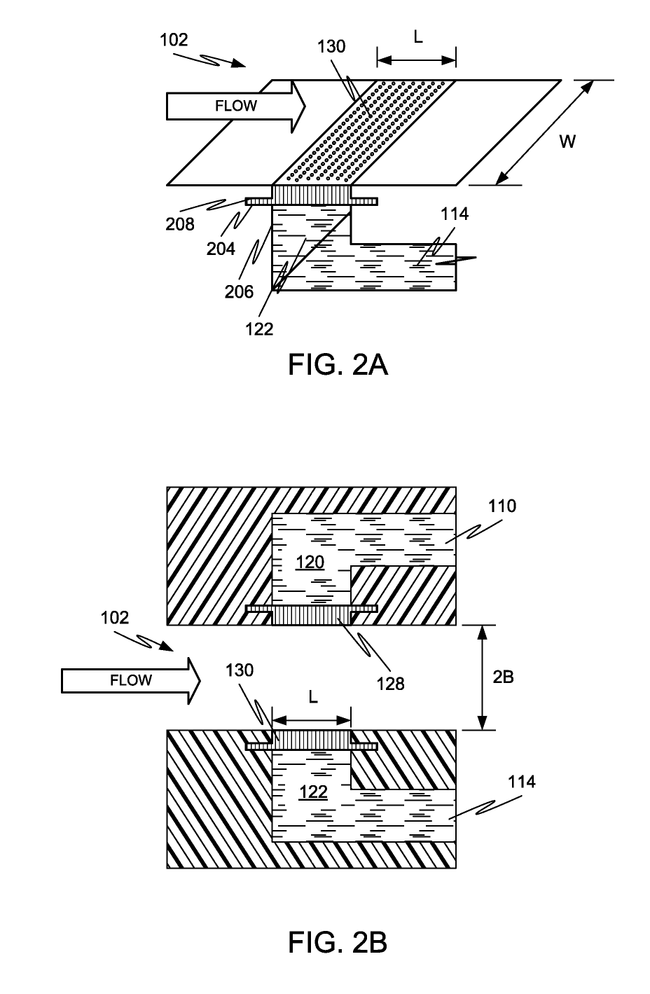

In an embodiment, the extraction fluid outlets 120, 122 and the filters 128, 130 therein extend across the width, w, of the microfluidic channel, as shown in FIG. 2A. The filters 128, 130 can have a length, L, parallel to the direction of flow, as shown in FIG. 2B. The length of the filters can be between 0.1 cm and 6 cm, inclusive, for example, 1 cm. The microfluidic channel also has a height, 2B, as shown in FIG. 2B. The microfluidic channel can have a height between 60 μm and 200 μm, inclusive.

The filters 124, 126, 128, and 130 can take the form of micro-sieves or nano-sieves. Such a sieve may be configured as a low flow resistance sieve. Examples of suitable sieves include “van Rijn” microsieves, “van Rijn” filters, and the like. The terms filter, sieve, micro-sieve, nano-sieve, micropore filter, and nanopore filter are all used interchangeably herein.

Referring again to FIG. 2A, the area around filter 130 of outlet channel 122 of FIG. 1 is shown in detail. Filter 130 is arranged in the opening connecting outlet channel 122 with microfluidic channel 102. In an embodiment, filter 130 can have a cross-section in the shape of an inverted “T”, as illustrated in FIGS. 2A-2B. To accommodate such a configuration of the filter, the outlet channel 122 can be provided with two opposed grooves 204 in sidewalls 206. The grooves 204 can receive two opposed tabs 208 of filter 130. Such a design can enable filter 130 to be installed by sliding the filter 130 into place. Likewise, the filter 130 can be removed from outlet channel 122 by sliding the filter 130 out of the outlet channel 122. The wall filters may also be fabricated in place during the construction of the microchannel device.

Filter 128, 130 can be of such size and shape as to eliminate gaps between the opening to the microfluidic channel 102 and the respective filter, thereby forcing the extraction fluid to flow through the respective filter. Filters 128, 130 can have a plurality of substantially straight, non-branching pathways, or pores, extending therethrough. These pores may be arrayed across the filter surface of the filter in a regular pattern, as shown in FIG. 2A, or in a random pattern (not shown). The density of the pores on the filter surface may be in the range of 1 million pores/cm² and 100 million pores/cm², inclusive. The size of the pores shown in FIG. 2A has been exaggerated for the purposes of illustration. Actual pore diameter can range from 0.4 μm to 10 μm, inclusive. Each filter may have a filter area in the range from 2 cm² to 200 cm², inclusive. Permeability of each filter can be in the range from 1×10⁻⁶ cm²s/g to 2×10⁻⁵ cm²s/g, inclusive. Of course, other dimensions and sizes for the pores and the filter can be selected in view of, for example, desired flow characteristics and/or particle retention.

In microfluidic channel 102 with filters 128, 130, fluid containing suspended particles, such as blood cells, flows from a stream in the microfluidic channel 102 through one of the wall filters 128, 130. At the same time, a streamwise pressure drop occurs along the length, L, of the filters 128, 130, which can cause the flow through the filters 128, 130 to reverse at a point along the filters 128, 130. This point corresponds to when the pressure in the microfluidic channel 102, due to the streamwise pressure drop, is below the pressure on the filtrate side 120, 122 of the respective filter 128, 130. This effect may be attributed to the relatively low flow resistance of the wall filters generate. The reverse flows through these wall filters can lead to substantially less extraction fluid flow through the extraction fluid outlets at high trans-filter pressures across the filters than would be expected. Moreover, as the exiting extraction fluid may contain components that are desired to be removed from the sample fluid, the reverse flow through the filters may return these components to the exiting sample fluid. Ideal steady state operation of the filter may be such that particles, which are filtered out by the filter, are carried away from the filter surface by the streamwise flow. However, if the filtration rate is too high, the convection of particles to the filter surface will be so great that the particles cannot be adequately carried away and the filter throughput will be further reduced.

This problem can be addressed by a combination of design features so as to simultaneously provide both sufficient transport of particles from the filter surface and avoid the negative trans-filter pressure difference. Such conditions that give rise to reverse flow through the filter can be mitigated and/or minimized through careful selection of microfluidic channel and filter dimensions while allowing for sufficient wall shear to avoid the buildup of particles from the sample fluid on the filter during flow of the fluid therethrough. Microfluidic channel height, filter length, flow characteristics and an overall system width can be tailored based on an analysis of hydraulic conditions. Such an analysis can include the effect of high trans-filter pressures on filter hydrodynamics and the requirement for sufficient wall shear for filter surface sweeping. The system may be designed to reduce, prevent or minimize the effect of this reversed flow to increase and/or maximize the utilization of the filter area and also simultaneously allow the flowing fluid to sweep particles (e.g., blood cells or platelets) off the surface of the filters.

A filter having a relatively shorter length can cause convection to occur over a shorter length, thereby resulting in a greater buildup of particles at the filter surface. On the other hand, a relatively longer filter can allow for backflow in a downstream portion of the filter, which can be compensated by an even greater convection over the upstream portion of the filter. This also leads to a greater buildup of particles, primarily at the upstream portion of the filter. FIG. 7 is a graph showing trans-filter pressure at a trailing end of the filter as a function of filter length for given flow conditions. At large filter lengths, trans-filter pressure at the trailing edge is negative and thus reverse flow through the filter exists. At smaller filter lengths, trans-filter pressure is positive, but may be susceptible to particle buildup due to convection effects. However, the length of the filter may be chosen such that backflow is incipient at the trailing edge of the filter (e.g., the length associated with point 701 in FIG. 7). At such a length, it may be possible to minimize the buildup of particles on the filter surface while avoiding reverse flow.

When the sample fluid and the extraction fluid do not have particles therein (or particles are sufficiently small or sparse (diffuse) so that they do not substantially interfere with the operation of the wall filters), the length, L, of the wall filter can approximately satisfy the equation:

$$L = \frac{1}{β} {cosh}^{- 1} ( \frac{{Q}_{1}}{{Q}_{2}} ) ,$$

where Q₁ is the volumetric flow rate down the microfluidic channel at the leading edge of the wall filter, Q₂ is the volumetric flow rate down the microfluidic channel at the trailing edge of the filter, and

$$β = \sqrt{\frac{3 μ A}{{B}^{3}}} ,$$

where μ is the viscosity of the sample fluid, A is the permeability of the filter, and 2B is the height of the microfluidic channel. At the calculated filter length, a positive trans-filter pressure is maintained along the length of the filter for the given flow rates. The flow rate through the filter is thus a maximum at an upstream end of the wall filter and progressively falls toward zero at a point that coincides with a downstream end of the wall filter.

When particles are present in the sample or extraction fluid of sufficient size to interact with the wall filter, the permeability of the filter can be affected by the particles, depending upon the concentration of particles at the wall. The flow behavior of the system is affected by the value of the Péclet number, Pe, defined as:

$$Pe = \frac{β B ( {Q}_{1} - {Q}_{2} )}{2 DW} ,$$

where Pe is the Péclet number, D is the diffusivity of the particles in the flowing sample fluid, and w is the width of the channel. Thus, the Péclet number is a function of β as well as microfluidic channel height, flow rates, particle diffusivity, and overall channel width.

There exists a complex relationship between the inlet concentration of particles (e.g., erythrocytes) and a critical value of the Péclet number, above which steady state filtration through the wall filters cannot be achieved. The critical Péclet number can be used to calculate the necessary design parameters for stable cross-flow filtration through the wall filters of the microfluidic channel. If the Péclet number is too large, steady state filtration will not be possible for the given flow rates. Accordingly, for a given channel geometry and flow rates, the overall channel width can be chosen, in view of the Péclet number, such that steady state filtration through the filter is possible. The filter, channel, and flow characteristics may be chosen in accordance with the following equation:

$${Q}_{1} - {Q}_{2} = \frac{2 DWPe}{β B} .$$

For example, in the case of blood, higher inlet hematocrits leads to a lower critical Péclet number and hence requires either lower filtrate flows or a wider system.

The minimum value of the filter width, Wₘᵢₙ, may be based on the critical Péclet number, Pe_{crit}. Thus, Wₘᵢₙ satisfies:

$${W}_{min} = \sqrt{\frac{3 μ A}{B}} \frac{{Q}_{1} - {Q}_{2}}{2 {DPe}_{crit}} .$$

The optimal filter length minimizes the wall particle concentration and is based on the value of βL that leads to incipient backflow. If this value is (βL)ₒₚₜ, then the optimal filter length, Lₒₚₜ, can be given by:

$${L}_{opt} = {( β L )}_{opt} \sqrt{\frac{{B}^{3}}{3 μ A}} .$$

The minimum filter area, sₘᵢₙ, can be given by:

$${S}_{min} = 2 {L}_{opt} {W}_{min} = ( {Q}_{1} - {Q}_{2} ) \frac{{( β L )}_{opt}}{{Pe}_{crit}} \frac{B}{D} .$$

The maximum filtrate flux, <J_{f}>ₘₐₓ, through the filter can be given by:

$${〈 {J}_{f} 〉}_{max} = \frac{{Q}_{1} - {Q}_{2}}{{S}_{min}} = \frac{{Pe}_{crit} D}{{( β L )}_{opt} B} .$$

Thus, while the filter permeability impacts the filter length and the filter width, it does not affect the maximum achievable filtrate flux or the minimum required filter area. The specific values of Pe_{crit} and (βL)ₒₚₜ will depend on the required filtration load and the inlet particle concentration distribution and may be determined through computer simulation.

For example, for a sample fluid of blood with a hematocrit of 0.33 flowing at 15 cc/min in a microfluidic channel, an extraction fluid with a hematocrit of 0 flowing at 15 cc/min in the microfluidic channel, and a desired flow rate through the filter of 16 cc/min, computer simulations show that Pe_{crit} is 3 and (βL)ₒₚₜ is 2.2. Thus, in a microfluidic channel having a height of 100 μm and for flowing blood with erythrocyte diffusivity, D, of 6×10⁻⁶ cm²/sec, the maximum filtrate flux, <J_{f}>ₘₐₓ, is 0.01 cm/min and the minimum filter area is 160 cm². The corresponding values of Wₘᵢₙ and Lₒₚₜ depend on filter permeability, A, which in turn depends upon pore diameter and density. For example, for a micro-sieve having a permeability of 1.39×10⁻⁵ cm²s/g, the optimal filter length, Lₒₚₜ, is 1.2 cm and the minimum filter width, Wₘᵢₙ, is 67 cm. The required minimum width may be realized by using multiple microfluidic channels, operated in parallel or in series. For example, 12 layers of microfluidic channels may be separately operated in a parallel, each with a filter width of 5.5 cm.

The required minimum filter area can be reduced in various ways. For example, for a specified filtrate flow rate, the filter area will be directly proportional to the channel height. Therefore, reductions in the microfluidic channel height will directly result in corresponding reductions in the minimum filter area. It is also possible to reduce the desired flow rate through the filter or the ratio of extraction fluid to sample fluid, either of which may reduce the filtration load on the filters. The effect of such changes on Pe_{crit} and (βL)ₒₚₜ is shown in Tables 1-2 below. The data presented is based on a maximum allowable erythrocyte concentration of 0.75. While changing this maximum concentration may change the specific model predictions for Pe_{crit} and (βL)ₒₚₜ, there should be little change in their ratio and hence little change in predicted minimum filter area. Note that Q₄ rate represents the flow rate through the filter minus the inlet extraction fluid flow rate, or the reduction in the exiting sample fluid flow rate as compared to the inlet sample fluid flow rate.

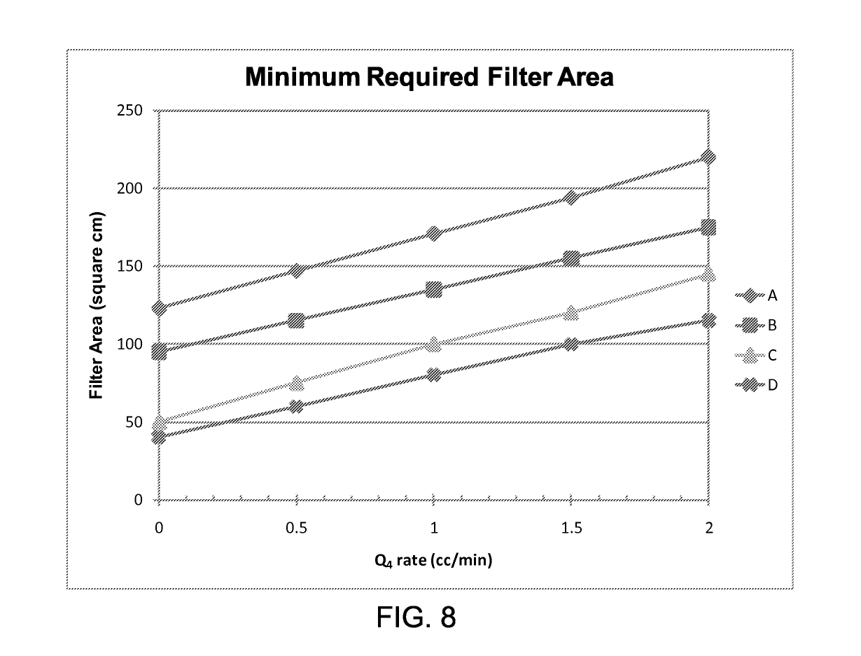

FIG. 8 shows the minimum required filter area (in cm²), versus the Q₄ flow rate (in cc/min). For each curve, an inlet blood flow rate of 15 cc/min was used to determine the appropriate Pe_{crit} and (βL)ₒₚₜ and to calculate the minimum filter area therefrom. In particular, the “A” curve reflects the minimum required filter area for a microfluidic channel having a height of 100 μm and an inlet extraction fluid flow rate of 15 cc/min. The “B” curve reflects the minimum required filter area for a microfluidic channel having a height of 80 μm and an inlet extraction fluid flow rate of 15 cc/min. The “C” curve reflects the minimum required filter area for a microfluidic channel having a height of 100 μm and an inlet extraction fluid flow rate of 7.5 cc/min. The “D” curve reflects the minimum required filter area for a microfluidic channel having a height of 80 μm and an inlet extraction fluid flow rate of 7.5 cc/min. Thus, higher extraction fluid flow rates may necessitate larger filter areas for a given blood flow rate, while smaller microfluidic channel heights can reduce the required filter areas.

TABLE 1
Pe_{crit} and (βL)ₒₚₜ based on filtrate rate for blood
flow rate (Q_{B}) of 15 cc/min and extraction fluid flow rate
(Q_{E}) of 15 cc/min (i.e., Q₁ = 30 cc/min).

| Filtrate Rate | | | |
|---|---|---|---|
| (Q₃ = Q₁ − Q₂) | Q₄ = Q₃ − Q_{E} | | |
| (cc/min) | (cc/min) | Pe_{crit} | (βL)ₒₚₜ |
| 15 | 0 | 3.4 | 2.0 |
| 15.5 | 0.5 | 3.1 | 2.1 |
| 16 | 1.0 | 2.8 | 2.1 |
| 16.5 | 1.5 | 2.6 | 2.2 |
| 17 | 2.0 | 2.5 | 2.3 |

TABLE 2
Pe_{crit} and (βL)ₒₚₜ based on filtrate rate for
blood flow rate of 15 cc/min and extraction fluid flow
rate of 7.5 cc/min (i.e., Q₁ = 22.5 cc/min).

| Filtrate Rate | | | |
|---|---|---|---|
| (Q₃ = Q₁ − Q₂) | Q₄ = Q₃ − Q_{E} | | |
| (cc/min) | (cc/min) | Pe_{crit} | (βL)ₒₚₜ |
| 7.5 | 0 | 2.9 | 1.5 |
| 8 | 0.5 | 2.4 | 1.6 |
| 8.5 | 1.0 | 2.1 | 1.7 |
| 9 | 1.5 | 1.8 | 1.7 |
| 9.5 | 2.0 | 1.7 | 1.9 |

Specific length and width requirements can be adjusted by careful selection of the filter permeability, A. For example, for a Pe_{crit} of 2.1, (βL)ₒₚₜ of 1.7, microfluidic channel height of 100 μm, and filter permeability of 1.39×10⁻⁵ cm²s/g, the optimal filter length, Lₒₚₜ, is 1.2 cm and the minimum filter width, Wₘᵢₙ, is 32 cm. Again, the minimum width may be realized using multiple microfluidic channel layers, such as 16 layers with 2 cm of filter width per layer or 7 layers with 4.5 cm of filter width per layer. Use of filters with lower permeability will increase the required filter length but decrease the filter width.

In addition to altering the physical dimensions of the microfluidic channel and filter, other mechanisms can be employed to avoid or mitigate reverse flow while allowing for sufficient shear to sweep the surface of the filter of particulate. For example, the low resistance of the wall filters may contribute to the pressure drop at the trailing edge of the filter becoming negative. Accordingly, higher flow resistance wall filters may be used instead to generate higher trans-filter pressures that dominate the pressure drop of the channel flow. The relationships provided herein provide a method for the selection of filters that make effective use of the filters by limiting the impact of flow reversal while maintaining sufficient shear to sweep clear the surface adjacent the microfluidic channel.

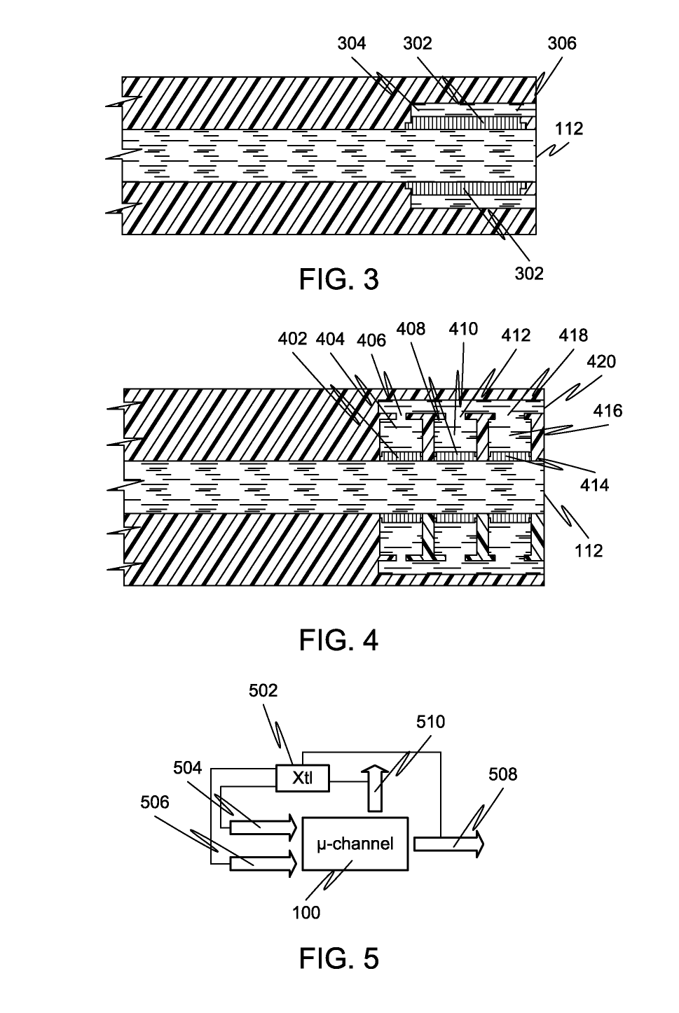

In an embodiment, an extraction fluid outlet channel on the filtrate side of the filter may be designed so as to generate a significant pressure drop along the filtrate side in the streamwise direction of the microchannel. This pressure drop on the filtrate side may compensate for the pressure drop along the main microchannel. An extraction fluid outlet channel that is properly sized may provide a pressure drop down the extraction fluid outlet channel such that the pressure difference across the filter is non-negative. Such an example is illustrated in FIG. 3. The sample fluid is allowed to exit through outlet 112 with extraction fluid being removed from the microfluidic channel through wall filters 302, similar to the embodiment of FIG. 1. However, in contrast to the arrangement of extraction fluid outlet channels in FIG. 1, the extraction fluid outlet channel 307 in FIG. 3 is sized and shaped such that a pressure drop from a leading point 304 to the trailing point 306 in the extraction fluid outlet channel 307 is substantial and duplicates the trend of the pressure drop in the microfluidic channel itself. Although shown as having a constant channel height in FIG. 3, a variable channel height for extraction fluid channel can be provided between the leading point 304 to the trailing point 306 to further effect pressure variations along the length of the filter 302. The reverse flow of extraction fluid back into the microfluidic channel is reduced and/or prevented because the falling pressure in the exit channel compensates to some extent the falling pressure in the microfluidic channel, both resulting from strain and viscosity (i.e., normal streamwise pressure drop in a confined channel).

In another example, the pressure across the filter at different points along the microfluidic channel can be tailored to correspond with the decrease in pressure between the leading edge of the filter and a trailing edge of the filter. As shown in FIG. 4, multiple wall filters 402, 408, and 414 are provided. Each wall filter is configured to remove fluid from the main channel and provide the removed fluid to a respective outlet region. The respective outlet region is coupled to a common fluid outlet channel 420 by way of a restriction such that the pressure in each respective outlet region, and thus on each respective filter, varies according to the size of the restriction. The restriction 406 in outlet 404 results in a relatively large pressure on the filtrate side of the filter 402. The relatively large restriction 418 in outlet 416 results in a relatively low pressure on the filtrate side of filter 414. The filtrate pressure in the outlet 410 past filter 408 has an intermediate pressure by virtue of the intermediate restriction 412 in outlet 410. Thus, the pressure on the receiving side of each filter can mirror the pressure drop in the microfluidic channel, thereby reducing and/or minimizing the chance of reverse flow of extraction fluid. Of course other mechanisms for altering the pressure in each outlet region, such as channel cross-section variations are also contemplated

The reverse flow of extraction fluid through the filter is not only a function of channel and filter geometry, but also flow rates. Accordingly, for a given channel and filter geometry, the flow rates through the channel and the filter can be chosen to minimize backflow. Thus, by controlling the ratio of sample fluid and extraction fluid flow rates, the user can control the hydrodynamic properties of the filter in the microfluidic channel. In the case of blood, the inlet flow of blood (Q_{B}) can be kept constant and the inlet flow of extraction fluid (Q_{E}) can be increased. This results in a net increase in the inlet flow (Q₁=Q_{B}+Q_{E}). As it may be desired to remove all of the extraction fluid through the filters, the resulting outlet flow (Q₂) is substantially equal to or less than the blood inlet flow (Q_{B}). Thus, by raising the extraction fluid flow, the ratio of inlet flow (Q₁) to outlet flow (Q₂) is increased, thereby increasing the filter length that can be used without backflow while simultaneously raising the overall shear rates within the system, which improves the removal of particulates.

As illustrated in FIG. 5, a controller 502 can regulate the inlet flow rate 504 of the sample fluid and the inlet flow rate of the extraction fluid 506 to the microfluidic device 100. The controller 502 can also regulate the extraction fluid outlet flow rate 510 and the sample fluid outlet flow rate 508. Preferably, the controller 502 performs this regulation function in accordance with the disclosed criteria for minimizing extraction fluid backflow through the filter while providing sufficient shear rates for particle removal. The controller can also control flow rates to achieve one or more design goals with respect to fluid processing, such as, but not limited to minimum or maximum sample fluid flow rates, shear criteria, and extraction fluid flow rates. The controller 502 can provide instructions to one or more pumps (not shown) to effect the necessary flow rate control.

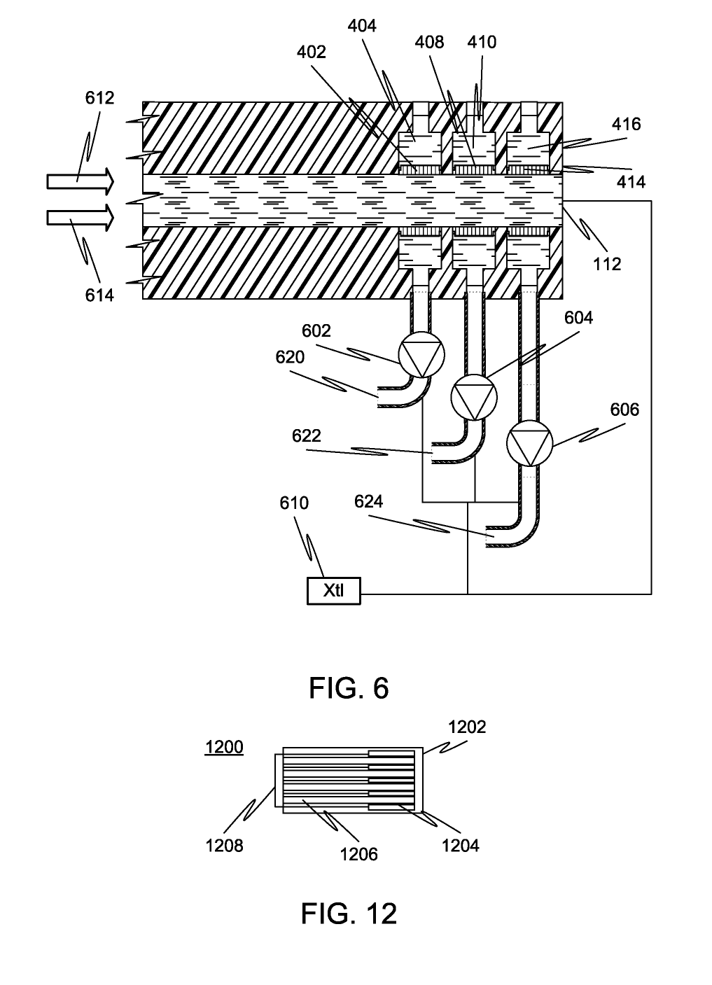

Referring to FIG. 6, instead of using orifices to control the pressure of each filter 404, 408, and 416, the flow rate from each filter can be regulated using a separate pump 602, 604, 606 or other fluid flow regulator. Each pump may extract fluid from outlets at the same position in the streamwise direction. The flows 620, 622, and 624 can be combined into a common extraction fluid flow from the pumps and conveyed back to the microfluidic channel as indicated at 612 and 614. The flow rates of each can be regulated by a controller 610.

Although particular embodiments have been described with regard to blood as the sample fluid, the methods, systems, and devices for separating fluids via cross-filtration disclosed herein are applicable to a wide variety of sample fluids. In cross-filtration, particles greater than a certain size in the fluid are retained in the microfluidic separation channel while at least a portion of the fluid and particles less than a certain size are allowed to pass through a wall filter or membrane. The wall filter or membrane may be parallel to the direction of flow in the microfluidic separation channel such that flow through the filter or membrane is substantially perpendicular to the fluid flow in the microfluidic separation channel.

In certain applications, an extraction fluid may not be necessary. Referring now to FIG. 9, an embodiment of a microfluidic separation device 900 is shown. Sample fluid containing particles is conveyed into microfluidic channel 902 through inlet 904. The microfluidic channel 902 can have a top wall 910 and a bottom wall 916. Within top wall 910 is a wall filter or membrane 908 while bottom wall 918 has a wall filter or membrane 918. The top wall filter 908 and the bottom wall filter 918 can allow fluid to pass therethrough into top extraction outlet 912 and bottom extraction outlet 920, respectively. The filters 908 and 918 may be configured to also allow particles less than a particular size to pass therethrough with the fluid. The extracted fluid can be conveyed by respective channels 914, 922. In some embodiments, outlet channels 914 and 922 may convey the extracted fluid to another device for further processing or to waste stream for discarding. The fluid exiting the microfluidic channel 902 through filters 908, 918 leaves behind a particle-rich flow, which can be removed through separation channel outlet 906. In some embodiments, outlet 906 may convey the particle-rich flow to another device for further processing or to waste stream for discarding.

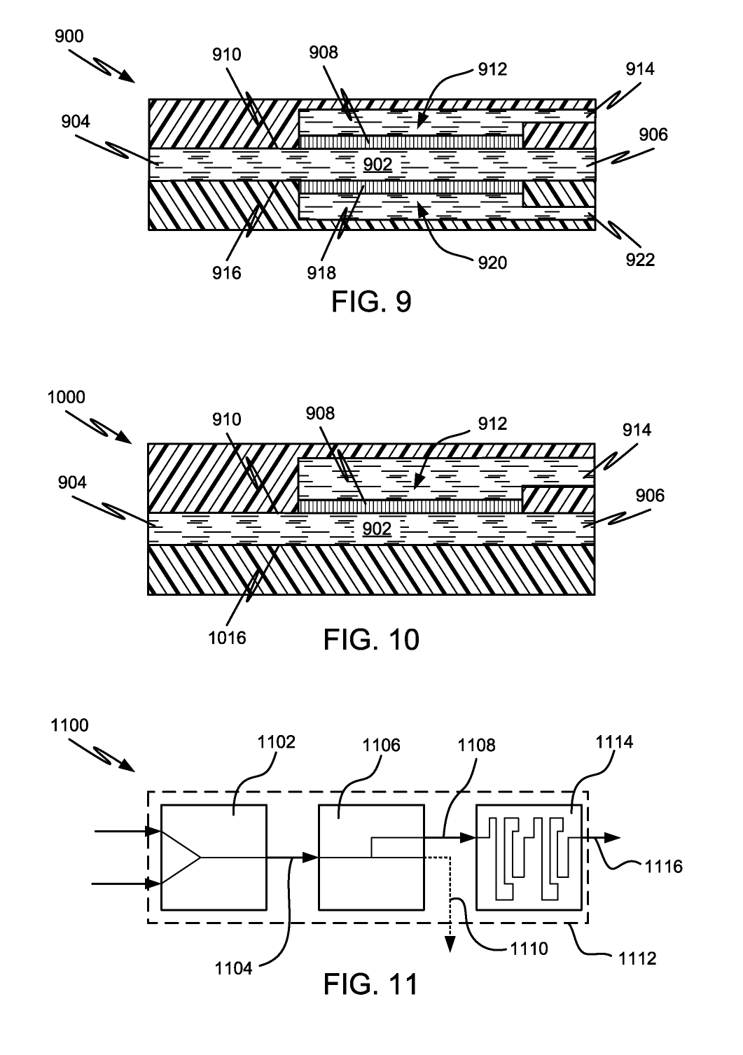

While the separation device can include wall filters or membranes on opposite walls of the microfluidic channel, such an arrangement is not required. In some embodiments, cross-filtration may be achieved using a single wall filter. Referring now to FIG. 10, an embodiment of a microfluidic separation device 1000 with a single wall filter 908 is shown. The separation device 1000 is substantially the same as separation device 900 shown in FIG. 9; however, separation device 1000 has a solid bottom wall 1016 rather than a wall filter therein. Thus, cross-flow filtration is performed only through top wall filter 908.

The separation systems, methods, and devices described herein can be used to provide particle-fluid separation in an integrated microfluidic unit. For example, the separation device can be provided on a common substrate or chip with one or more microfluidic processing devices. Such an integrated microfluidic unit may be referred to as a lab-on-a-chip device or a micro-total analysis system. By integrating the separation device with other microfluidic devices on a common substrate or chip, the integrated microfluidic unit may be able to take advantage of reduced fluid volumes and process intensification. The integrated microfluidic unit may enable liquid/particle separations within the microfluidic system, which were previously required to be performed in standard macroscale chemical processing equipment.

For example, the integrated processing devices may include microfluidic reactor systems or microfluidic emulsion systems. In an example, the separation device may separate liquid reaction products from particular catalysts in a microfluidic reactor system. In another example, the separation device may separate crystallized products from a liquid reaction medium in a microfluidic reactor system. In still another example, the separation device may separate microcapsules made by a coascervation process in a microfluidic emulsion system. Of course, the separation device can be used with other microfluidic processing devices to separate liquid and particles according to one or more contemplated embodiments.

Referring now to FIG. 11, a schematic diagram of a microfluidic unit 1100 is shown. A first processing device 1102 can produce a fluid stream with particles therein. The fluid stream from the first processing device 1102 can be conveyed through channel 1104 to separation device 1106. The separation device 1106 can employ the configurations disclosed herein to separate particles from the fluid using cross-filtration. The filtered fluid can be conveyed through channel 1108 while the particle-rich fraction is conveyed through channel 1110. Channel 1108 can be connected to a second processing device 1114 while channel 1110 can be connected to a waste stream. Alternately, channel 1108 can be connected to the waste stream while channel 1110 can be connected to the second processing device 1114. The second processing device 1114 can process the filtered fluid or the particle-rich fraction and convey the processed component through outlet channel 1118.

The first and second processing devices 1102, 1114 and the separation device 1106 can be integrated on a common substrate or chip 1112. For example, devices 1102, 1106, and 1114 may represent different portions of a common microfluidic channel network adapted for their respective purposes. Devices 1102, 1106, and 1114 can have one or more channels with a dimension less than 1 mm. Of course, either of the first and second processing devices 1102, 1114 can be removed according to one or more contemplated embodiments. Additional processing devices can also be added on the same substrate or chip 1112 according to one or more contemplated embodiments. Microfluidic unit 1100 can also include additional components for fluid processing, such as, but not limited to, one or more fluid conveyance mechanisms, controllers, and fluid connection ports.

A separation device may be provided as multiple sub-channels or a single channel. In cases where there are multiple sub-channels, the area of the permeable portion of the channel wall and the width thereof may be divided among the sub-channels. For example, the multiple sub-channels may operate in parallel with an effect similar to that of a single wider channel. To illustrate, referring to FIG. 12, a device 1200 can have multiple sub-channels 1206, each with one or more permeable wall portions 1204. The device 1200 can further include an inlet manifold 1208 and an outlet manifold 1202 that receives and partitions the separated flows from the sub-channels 1206. Note that any of the above embodiments may be provided as multiple sub-channels or a single channel. For example, the manifolds can fluidly couple, and interface, to other microfluidic processing components as discussed above with respect to FIGS. 9-11.

Computational modeling of fluid flow may also provide important insights into filter flow characteristics and separation device design. Although particular configurations have been discussed herein, other configurations can also be employed. Furthermore, the foregoing descriptions apply, in some cases, to examples generated in a laboratory, but these examples can be extended to production techniques. For example, where quantities and techniques apply to the laboratory examples, they should not be understood as limiting. In addition, although blood as sample fluid has been specifically described herein, the techniques described herein are applicable to other types of fluids as well.

It is, thus, apparent that there is provided, in accordance with the present disclosure, methods, apparatus, and systems for separating fluids. Many alternatives, modifications, and variations are enabled by the present disclosure. Features of the disclosed embodiments can be combined, rearranged, omitted, etc., within the scope of the invention to produce additional embodiments. Furthermore, certain features may sometimes be used to advantage without a corresponding use of other features. Accordingly, Applicants intend to embrace all such alternatives, modifications, equivalents, and variations that are within the spirit and scope of the present invention.

1. A microfluidic separation device comprising:
a separation channel having an input end and an output end separated by a length and defining a direction of flow through the separation channel;
at least one inlet port being located proximate to the input end;
at least one extraction fluid outlet port and a sample fluid outlet port, the outlet ports being located proximate to the output end;
each extraction fluid outlet port having a wall filter that forms a portion of a wall of the separation channel; and
at least one fluid drive configured to convey sample fluid into the separation channel through the at least one inlet port and sample and extraction fluids out of the separation channel through the respective outlet ports at respective volumetric flow rates,
wherein the wall filter has a length along said direction of flow that is between 0.1 cm and 6 cm, and
the separation channel is a single channel or a plurality of sub-channels.

2. The device of claim 1, wherein the separation channel has a height and a width, both the height and the width are perpendicular to the direction of flow, the height is less than the width, the height is between 60 μm and 200 μm, and when the separation channel is a plurality of sub-channels, the width is a combined width of the sub-channels.

3. The device of claim 1, wherein a filter area of the wall filter is between 2 cm² and 200 cm², and when the separation channel is a plurality of sub-channels, the filter area is a combined filter area of the sub-channels, each sub-channel having a sub-filter representing a portion of said wall filter.

4. The device of claim 1, wherein the wall filter has a plurality of pores therein, and a diameter of each pore is between 0.4 μm and 10 μm.

5. The device of claim 4, wherein the wall filter has a pore density of between 1 million pores per cm² and 100 million pores per cm².

6. The device of claim 1, wherein the wall filter has a permeability of between 1×10⁻⁶ cm²s/g and 2×10⁻⁵ cm²s/g.

7. A microfluidic separation device comprising:
a separation channel having an input end and an output end, the separation channel having a height less than 300 μm;
at least one inlet port located proximate to the input end;
an extraction fluid outlet port and a sample fluid outlet port, the outlet ports being located proximate to the output end;
the extraction fluid outlet port having a wall filter that forms a portion of a wall of the separation channel; and
at least one fluid drive configured to convey sample fluid into the separation channel through the at least one inlet port and sample and extraction fluids out of the separation channel through the respective outlet ports at respective volumetric flow rates,
wherein the wall filter has a length, L, in a direction of flow from the input end to the output end of the separation channel that is approximately as given by:
$$L = \frac{1}{β} {cosh}^{- 1} ( \frac{{Q}_{1}}{{Q}_{2}} ) ,$$
where Q₁ is the volumetric flow rate down the microfluidic channel at the leading edge of the filter, Q₂ is the volumetric flow rate down the microfluidic channel at the trailing edge of the filter, and
$$β = \sqrt{\frac{3 μ A}{{B}^{3}}} ,$$
where μ is the viscosity of the sample fluid, A is the permeability of the filter, and 2B is the height of the separation channel, and
the separation channel is a single channel or a plurality of sub-channels.

8. The device of claim 7, wherein the extraction fluid outlet port is coupled to an extraction fluid inlet port by another channel such that fluid exiting the separation channel through the extraction fluid outlet port can be returned to the separation channel via the extraction fluid inlet port.

9. The device of claim 7, wherein the wall filter has pores with sizes no greater than 1000 nm.

10. The device of claim 7, wherein a ratio of a width of the separation channel to the height of the separation channel is more than 50, and when the separation channel is a plurality of sub-channels, said width is a combined width of the sub-channels.

11-26. (canceled)

27. A method of filtering fluid in a laminar cross-flow, comprising:
flowing at least one fluid, at a channel flow rate, through a microfluidic channel having a wall filter in a wall of the channel, the channel flow rate being a volume flow rate at an upstream end of the channel; and
drawing a portion of the at least one fluid through the wall filter at a filtering rate, the filtering rate being a volume flow rate of the drawing,
wherein the channel flow rate and the filtering rate are such that the flow of fluid through the wall filter is at a maximum positive rate at an upstream end of the wall filter and progressively falls toward zero at a point that coincides with a downstream end of the wall filter, and the channel is a single channel or multiple sub-channels.

28. The method of claim 27, wherein the flowing includes flowing the at least one fluid at a rate such that the flow is laminar.

29. The method of claim 27, wherein the microfluidic channel has a height of less than 600 μm.

30. The method of claim 27, wherein the wall filter has a pore size no greater than 1000 nm.

31. The method of claim 27, wherein the wall filter has a pore size no greater than 800 nm.

32. (canceled)

33. The method of claim 27, wherein said fluid includes blood.

34. The method of claim 27, wherein pores of the filter are sized so as to inhibit the passage of particles in the fluid through the filter.

35. (canceled)

36. The method of claim 27, wherein the flowing and the drawing are such that a positive pressure difference from the microfluidic channel across the filter is maintained at all points of the filter.

37-44. (canceled)

45. The device of claim 1, wherein said at least one inlet port includes at least one extraction fluid inlet port and a sample fluid inlet port, and the at least one fluid drive is configured to convey sample and extraction fluids into the separation channel through the respective inlet ports.

46. The device of claim 7, wherein said at least one inlet port includes at least one extraction fluid inlet port and a sample fluid inlet port, and the at least one fluid drive is configured to convey sample and extraction fluids into the separation channel through the respective inlet ports.
